(19) United States
(12) Patent Application Publication
(10) Pub. No.: US 2007/0237097 A1
(43) Pub. Date: Oct. 11, 2007

(54) Method and apparatus for generating a degree-constrained minimum spanning tree

(76) Inventors: Rohit Kumar Maharana, Hyderabad (IN); Vivek Dubey, Lucknow (IN)

Correspondence Address: MOTOROLA, INC., LAW DEPARTMENT, 1303 E. ALGONQUIN ROAD, SCHAUMBURG, IL, 60196, US

(21) Appl. No.: 11/394,075

(22) Filed: Mar. 29, 2006

(51) Int. Cl. H04L 12/28; H04L 12/56

(52) U.S. Cl. 370/255; 370/400

(57) ABSTRACT

A method and apparatus for generating a degree-constrained minimum spanning tree (MST) may include a plurality of point-to-point (P2P) packet switching nodes for receiving and sending data packets; a plurality of point-to-multi-point (P2MP) packet switching nodes for sending and receiving the data packets; and a plurality of transmission links coupling pairs of the plurality of packet switching nodes, where each of the plurality of transmission links has a distance. A path computation module may determine a degree-constrained MST such that each of the plurality of P2P packet switching nodes has a degree of two. An extended Bellman-Ford algorithm successively analyzes each of the plurality of packet switching nodes as a present node and calculates the degree-constrained MST as a function of the distance of each of the plurality of transmission links and whether a previous node from the present node is a P2P packet switching node or a P2MP packet switching node.

### BACKGROUND OF INVENTION

It has become increasingly useful to interconnect a plurality of data processing elements by means of a packet switching network in which data is transmitted as data assemblages called “data packets”. Such networks include a plurality of interconnected switching nodes. Such packet networks can become quite large with an extensive geographical distribution. In such a situation, the selection of an efficient path between two end nodes which wish to communicate with each other becomes of paramount importance. The general problem which must be solved at the network level is to find a path between a source and a destination node. In the prior art, the major criteria for selecting paths between nodes in packet networks are minimum hop count and minimum path length (distance). The hop count is the number of links used to construct the path between the two end nodes. The path length is a function of the overall transmission delay imposed by the path between the two end nodes.

The choice of a routing algorithm is not easy because it must satisfy a large number of often conflicting requirements. This algorithm must be simple to implement, and it must ensure a correct progress of the packets whatever the disturbance on the network. The algorithm must be able to provide satisfying results despite of the traffic variations and the network topology. It must also ensure the equity between the different end users and provide an equal distribution of the rights to access the network. At last, the routing algorithm must allow, when possible, to exploit the network in an optimal way, according to a criterion which can vary with the utilization type. In most of the cases, the network is realized in a way to minimize the packet transit time and to transfer the maximum number of packets. In other cases, the objective is to decrease the communication cost, or to develop a reliable network able to operate correctly either in case of catastrophic line, node failure or peaks of traffic.

In network theory, algorithms such as Prim's, Kruskal's and Dijkstra's have been used to find the minimum cost tree for a network. However, there is a need for near optimal cost trees that satisfy other constraints than just cost. Thus, a need exists, not met in the prior art, of generating a minimum spanning tree for a network, where cost is not the only factor in the generation of the minimum spanning tree.

### BRIEF DESCRIPTION OF THE DRAWINGS

Representative elements, operational features, applications and/or advantages of the present invention reside inter alia in the details of construction and operation as more fully hereafter depicted, described and claimed—reference being made to the accompanying drawings forming a part hereof, wherein like numerals refer to like parts throughout. Other elements, operational features, applications and/or advantages will become apparent in light of certain exemplary embodiments recited in the Detailed Description, wherein:

FIG. 1 representatively illustrates a packet communication system in accordance with an exemplary embodiment of the present invention;

FIG. 2 representatively illustrates a packet communication subsystem in accordance with an exemplary embodiment of the present invention;

FIG. 3 representatively illustrates a packet communication system in accordance with another exemplary embodiment of the present invention;

FIG. 4 representatively illustrates a packet communication system in accordance with yet another exemplary embodiment of the present invention; and

FIG. 5 representatively illustrates a packet communication system in accordance with still another exemplary embodiment of the present invention. Elements in the Figures are illustrated for simplicity and clarity and have not necessarily been drawn to scale. For example, the dimensions of some of the elements in the Figures may be exaggerated relative to other elements to help improve understanding of various embodiments of the present invention. Furthermore, the terms “first”, “second”, and the like herein, if any, are used inter alia for distinguishing between similar elements and not necessarily for describing a sequential or chronological order. Moreover, the terms “front”, “back”, “top”, “bottom”, “over”, “under”, and the like in the Description and/or in the Claims, if any, are generally employed for descriptive purposes and not necessarily for comprehensively describing exclusive relative position. Any of the preceding terms so used may be interchanged under appropriate circumstances such that various embodiments of the invention described herein may be capable of operation in other configurations and/or orientations than those explicitly illustrated or otherwise described.

### DETAILED DESCRIPTION OF EXEMPLARY EMBODIMENTS

The following representative descriptions of the present invention generally relate to exemplary embodiments and the inventor's conception of the best mode, and are not intended to limit the applicability or configuration of the invention in any way. Rather, the following description is intended to provide convenient illustrations for implementing various embodiments of the invention. As will become apparent, changes may be made in the function and/or arrangement of any of the elements described in the disclosed exemplary embodiments without departing from the spirit and scope of the invention.

For clarity of explanation, the embodiments of the present invention are presented, in part, as comprising individual functional blocks. The functions represented by these blocks may be provided through the use of either shared or dedicated hardware, including, but not limited to, hardware capable of executing software. The present invention is not limited to implementation by any particular set of elements, and the description herein is merely representational of one embodiment.

The terms “a” or “an”, as used herein, are defined as one, or more than one. The term “plurality,” as used herein, is defined as two, or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, an object code, a shared library/dynamic load library and/or other sequence of instructions designed for execution on a computer system. A component may include a computer program, software application, or one or more lines of computer readable processing instructions.

Software blocks that perform embodiments of the present invention can be part of computer program modules comprising computer instructions, such control algorithms that are stored in a computer-readable medium such as memory. Computer instructions can instruct processors to perform any methods described below. In other embodiments, additional modules could be provided as needed.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

Multicasting comprises concurrently sending the same information to a group of different destinations. To support a large number of multicast sessions efficiently, the network must transport the information exchanged in those sessions using as few network resources as possible. Generally, a minimum spanning tree is established for the network so as to utilize network resources efficiently. The following representative embodiments of the invention present a novel method of generating a degree-constrained minimum spanning tree that takes into account branching point-to-multipoint (P2MP) nodes and non-branching point-to-point (P2P) nodes. The degree-constrained minimum spanning tree may not have the least cost, but may have near optimal cost.

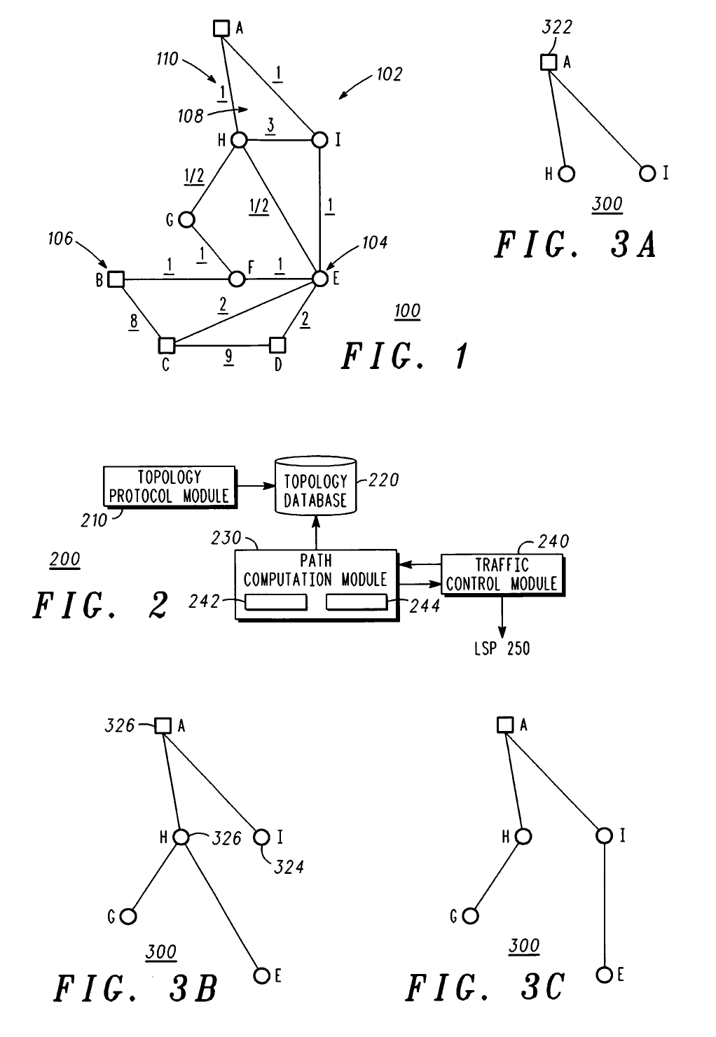

FIG. 1 representatively illustrates a packet communication system 100 in accordance with an exemplary embodiment of the present invention. In an embodiment, packet communication system 100 includes a plurality of packet switching nodes 102 for sending and receiving data packets, and a plurality of transmission links 108 coupling pairs of plurality of packet switching nodes 102.

Packet communication system 100 may be a Multi Protocol Label Switching (MPLS) network where incoming data packets are assigned a “label” and forwarded along a Label Switch Path (LSP) where each switching node makes forwarding decisions based solely on the contents of the label. At each hop, the switching node strips off the existing label and applies a new label which tells the next hop how to forward the packet. LSP's may be established by network operators for a variety of purposes, such as to guarantee a certain level of performance, to route around network congestion, or to create IP tunnels for network-based virtual private networks. An LSP can be established that crosses multiple Layer 2 transports such as ATM, Frame Relay or Ethernet. In an embodiment, MPLS may create end-to-end circuits with specific performance characteristics across any type of transport medium, eliminating the need for overlay networks or Layer 2 only control mechanisms.

As a data packet of a connectionless network layer protocol travels from one switching node to the next, each switching node may make an independent forwarding decision for that data packet. That is, each switching node may analyze the data packet's header, and each switching node runs a network layer routing algorithm. Each switching node independently chooses a next hop for the data packet, based on its analysis of the packet's header and the results of running the routing algorithm. Packet headers contain considerably more information than is needed simply to choose the next hop. Choosing the next hop may comprise two functions. The first function may partition the entire set of possible packets into a set of “Forwarding Equivalence Classes (FECs)”. The second may map each FEC to a next hop. Insofar as the forwarding decision is concerned, different data packets which get mapped into the same FEC are indistinguishable. All data packets which belong to a particular FEC and which travel from a particular switching node will follow the same path (or if certain kinds of multi-path routing are in use, they will all follow one of a set of paths associated with the FEC).

In conventional IP forwarding, a particular switching node will typically consider two data packets to be in the same FEC if there is some address prefix X in that router's routing tables such that X is the “longest match” for each packet's destination address. As the packet traverses the network, each hop in turn reexamines the packet and assigns it to a FEC.

In MPLS, the assignment of a particular packet to a particular FEC is done just once, as the packet enters the network. The FEC to which the packet is assigned is encoded as a short fixed length value known as a “label”. When a packet is forwarded to its next hop, the label is sent along with it; that is, the packets are “labeled” before they are forwarded. At subsequent hops, there is no further analysis of the packet's network layer header. Rather, the label is used as an index into a table which specifies the next hop, and a new label. The old label is replaced with the new label, and the packet is forwarded to its next hop. In the MPLS forwarding paradigm, once a packet is assigned to an FEC, no further header analysis is done by subsequent switching nodes; all forwarding is driven by the labels. Further details on MPLS may be found in the Request for Comment (RFC) 3031 of the Internet Engineering Task Force (IETF).

Plurality of packet switching nodes 102 may comprise any computer like device such as a router, enterprise server, video servers, portable or desktop computer, cellular phone, PDA, and the like. For example, and without limitation, one or more of plurality of switching nodes 102 may be a Label Switching Router (LSR) for operation in an MPLS. Plurality of packet switching nodes 102 may each comprise a data processing system which provides data communications services to all connected nodes. Plurality of packet switching nodes 102 may each comprise one or more decision points within the node, at which incoming data packets are selectively routed on one or more of the outgoing communication links terminated within that node or at another node. Such routing decisions are made in response to information in the header of the data packet.

In an embodiment, one or more of plurality of switching nodes 102 may comprise one or more of point-to-point (P2P) switching nodes 104, which simply route an incoming data packet received on an inbound transmission link to an outbound transmission link. P2P switching nodes 104 do not duplicate (i.e. branch) data packets for transmission to multiple destinations and are represented in FIG. 1 by the circular nodes. In an embodiment, one or more of plurality of switching nodes 102 may comprise one or more point-to-multipoint (P2 MP) switching nodes 106, which may duplicate (branch) an incoming data packet and transmit duplicates of the incoming data packet to multiple destinations. Plurality of P2 MP switching nodes 106 are represented in FIG. 1 by square nodes.

Plurality of transmission links 108 may be wireline or wireless links. Further plurality of transmission links 108 may each have a distance 110 associated with it, where the distance 110 may represent the physical distance, the traffic congestion, an impairment, or any other measurement of cost or resistance to the flow of data packets.

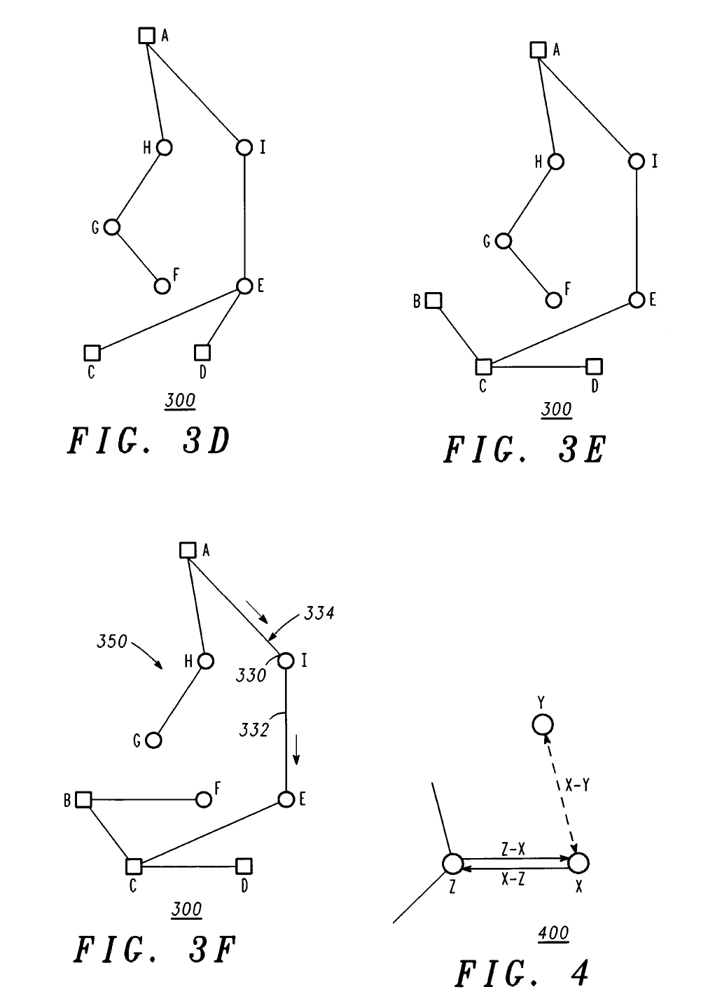

FIG. 2 representatively illustrates a packet communication subsystem 200 in accordance with an exemplary embodiment of the present invention. The elements depicted in FIG. 2 may be located in one or more of plurality of packet switching nodes 102 and/or distributed among one or more of plurality of packet switching nodes 102. Packet communication subsystem 200 may comprise a topology protocol module 210, topology database 220, path computation module 230 and traffic control module 240. The elements depicted in FIG. 2 are merely representative. Other configurations and other elements of packet communication subsystem 200 may be used to implement the method of the invention and are within the scope of the invention.

Topology protocol module 210 may run a routing protocol that supplies the topology of packet communication system 100 to topology database 220. For example and without limitation, topology protocol module 210 may be an Open Shortest Path First (OSPF) routing protocol in an MPLS network. In an embodiment, topology protocol module 210 may periodically or continuously update data in topology database 220. For example, topology protocol module 210 may periodically or continuously update the configuration and/or state of plurality of packet switching nodes 102 and plurality of transmission links 108 in packet communication system 100, such that topology database 220 comprises the most recent configuration and/or state of packet communication system 100.

In an embodiment, traffic control module 240 may operate to may establish an LSP 250 in an MPLS network. For example, traffic control module 240 may be a Label Traffic Control System (LTCS) and implement MPLS network functionality. In order to establish an LSP 250, traffic control module 240 requires a path from a source node to destination node(s). In an embodiment, traffic control module 240 may make a request to path computation module 230 giving inputs like source address, destination address(es) and traffic engineering constraints. In an embodiment, path computation module 230 may be a Constrained Shortest Path First (CSPF) module in an MPLS network. Once path computation module 230 receives the request from traffic control module 240 for path computation, it may access data from topology database 220 and compute the path. The computed path may be returned to traffic control module 240, where traffic control module initiates establishment of the path from a source node to destination node(s), which may be an LSP 250. In an embodiment, traffic control module 240 may send control plane signaling messages (for example RSVP-TE signaling) along with the explicit path returned by path computation module 230 to establish the LSP 250. Now traffic control module 240 knows which path data packets from a particular source address with a particular destination address are to follow, and may reserve bandwidth to send the data packets through that path.

In an embodiment, the LSP 250 may be represented by a minimum spanning tree (MST). Given a connected, undirected topology of switching packet nodes coupled by a plurality of transmission links, a spanning tree of that topology may be sub-topology, which is a tree and connects all the plurality of switching packets together. A single topology can have many different spanning trees. As described above, a distance may be assigned to each transmission link, which is a number representing how unfavorable it is, and the distance may be used to assign a weight to a spanning tree by computing the sum of the distances of the plurality of transmission links in that spanning tree. A minimum spanning tree may be a spanning tree with a spanning tree weight less than or equal to the spanning tree weight of every other spanning tree.

In case of a tie, there could be several minimum spanning trees. In particular, if all spanning tree weights are the same, every spanning tree is minimum. A minimum spanning tree is in fact the minimum-cost subgraph connecting all plurality of switching nodes.

One method of obtaining an MST is through the use of the Bellman-Ford Algorithm described by D. Bertsekas and R. Gallager in Data Networks—Prentice-Hall 1987 Englewood Cliffs, N.J. The objective of the algorithm is to find a path joining two nodes with the minimum distance, the distance being defined to reflect the congestion or unfavorability of the link. The algorithm starts from a source node and first finds the shortest path lengths subject to the constraint that the paths contain at most one link. Then, it finds the shortest path lengths with a constraint of paths of at most two links, and so forth.

Let
N the number of nodes (labeled 1, 2, . . . , N).
M=the number of unidirectional links. It is assumed that there is at most one unidirectional link going from one node to another, and so a link can be identified by its end points.
h=the number of hops,
D (i,h)=the shortest (≦h) path length from source node (1) to node (i). By convention D (1,h)=0 for all h.
dᵢⱼ=the length of the link connecting node (i) to node 0). By convention dᵢⱼ=∞ if nodes (i) is not connected to node (j).
Initially D(i,0)=∞ for all I≈1

For each successive 0≦h, D(i,h+1)=minⱼ[D(j,h)+dⱼᵢ], j=1, . . . , N for all I≠1 A path can contain at most N−1 links. In the worst case, the algorithm must be iterated N−1 times, each iteration must be done for N−1 nodes, and, for each node, the minimization must be taken over no more than N−1 alternatives. Thus the amount of computation grows at worst as N³.

Let D(i) be the shortest path length from node (1) to (i), with D(1)=0, then the equation converges with h=N−1 and can be written:
D(i)=minⱼ[D(j)+dⱼᵢ], for all I≠1
D(1)=0

This is called Bellman's equation and expresses that the shortest path length from node (1) to (i) is the sum of the path length to the node before (i) (on the shortest path) plus the distance on the final link of the path.

Although the Bellman-Ford Algorithm solves for the minimum cost spanning tree, it does not take into account the degree of each of the nodes in the network topology. This is known as the degree-bound constraint and requires that certain nodes in the MST should not have a degree greater than a specified limit. In an embodiment, packet communication system 100 may include P2P switching nodes described above, which may not have a degree greater than two. The degree is the sum of the inbound transmission links and the outbound transmission links to a switching node.

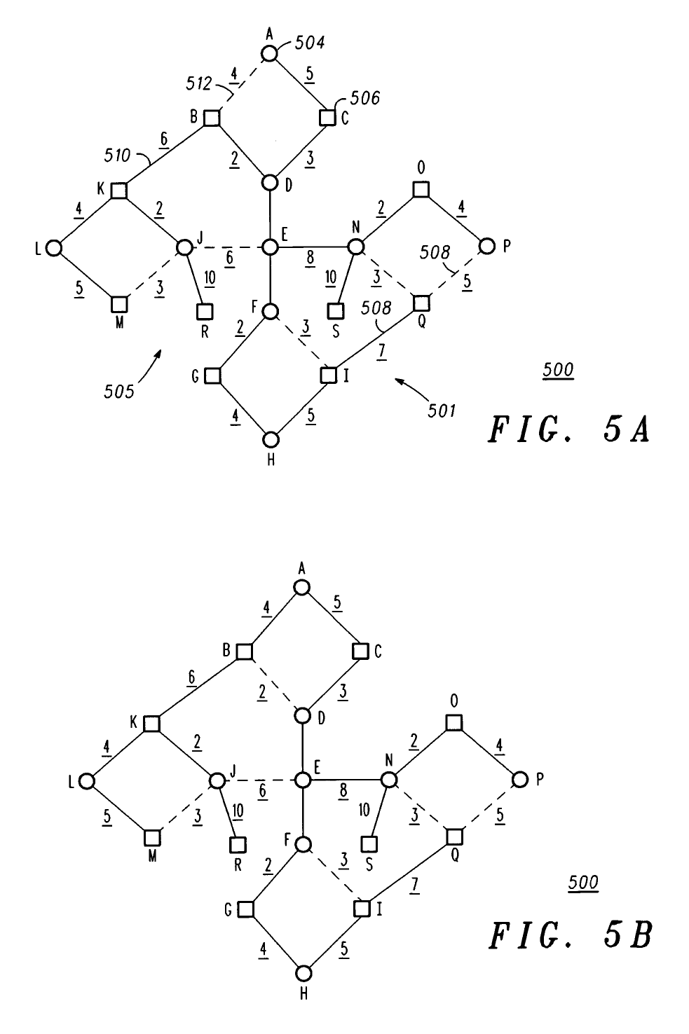

In an embodiment, an extended Bellman-Ford algorithm 242 and a link replacement algorithm 244 may be used to generate a degree-constrained MST 250. As shown, path computation module 230 may comprise an extended Bellman-Ford algorithm 242 and a link replacement algorithm 244 that may be used to generate a degree-constrained MST, and hence an LSP 250. As described above, upon receiving a request from traffic control module 240, path computation module 230 may use topology data taken from topology database 220 to generate LSP 250. In an embodiment, path computation module 230 may use extended Bellman-Ford algorithm 242 and link replacement algorithm 244 to generate a degree-constrained MST, and hence an LSP 250. An embodiment of an operation of extended Bellman-Ford algorithm 242 and link replacement algorithm 244 are depicted in FIGS. 3-5.

In an exemplary embodiment, the degree-constrained MST may be generated in two phases. The first phase involves executing the extended Bellman-Ford algorithm 242 on the topology of packet communication system 100. The extended Bellman-Ford algorithm 242 executes the traditional Bellman-Ford algorithm with the additional constraint to select nodes based on a degree, in this embodiment, a constraint that all P2P switching nodes 104 have a degree no greater than two. This keeps the number of P2P switching nodes 104 violating the degree constraint to a minimum. If, after executing the extended Bellman-Ford algorithm 242, there are P2P switching nodes 104 in the degree-constrained MST that have a degree greater than two, then link replacement algorithm 244 may be executed to replace links included in the degree-constrained MST with links not included in the MST in order to ensure the remaining P2P switching nodes 104 have a degree no greater than two.

FIG. 3 representatively illustrates a packet communication system 300 in accordance with another exemplary embodiment of the present invention. FIG. 3 has been segmented into FIGS. 3A-3F to illustrate the steps of the extended Bellman-Ford algorithm 242. FIGS. 3A-3F represent the packet communication system 100 described with reference to FIG. 1, with node A as a source node.

As described above, the degree of a node is the sum of the in-degree and the out-degree, where the in-degree is the number of transmission links entering the node, and the out-degree is the number of transmission links moving out of the node. In an embodiment, the degree-constrained MST will be such that P2P switching nodes 104 have an in-degree of one and an out-degree of one, which is a degree of two. P2 MP switching nodes 106 may have an in-degree of one and an out-degree greater than 1.

The extended Bellman-Ford algorithm 242 uses the traditional Bellman-Ford algorithm to analyze each switching node (present node), but also makes decisions based on the P2 MP capability and out-degree of the previous node (from the present node) using the following process:
1) For each node analyzed (present node), add a field called “prev_node_p2 mp_flag” that indicates if the previous node (the one feeding the current node—i.e. parent node) is a P2 MP capable or not;
2) For each node analyzed (present node), add a field “p2 mp_flag” that indicates if the node is P2 MP capable; and

3) For each iteration (hops away=1,2 . . . (number of nodes−1)), at every present node “J,” select the incoming transmission link (K₁, J) or (K₂, J) as follows (where K₁ and K₂ are each a previous node of present node J):

TABLE 1

| | | New | | | |
|---|---|---|---|---|---|
| | Previous | Previous | | | |
| Case | Node of J | Node of J | Conditions | | Action |
| A | K₁ is P2MP | K₂ is P2MP | Distance[J] as | If Distance [J] | Update: |
| | | | in Bellman- | via K₁ and K₂ | Distance [J] |
| | | | Ford | are same, | Prev_node_p2mp_flag[J] |
| | | | algorithm | select K₁ as | Previous node[J] |
| | | | | K₁'s router id is | Out-degree[K₁] |
| | | | | less | Out-degree[K₂] |
| B | K1 is P2P | K2 is P2MP | K₂ is chosen | | Update: |
| | | | | | Distance [J] |
| | | | | | Prev_node_p2mp_flag[J] |
| | | | | | Previous node[J] |
| | | | | | Out-degree[K₁] |
| | | | | | Out-degree[K₂] |
| C | K1 is P2MP | K2 is P2P | K₁ is chosen | | No update |
| D | K1 is P2P | K2 is P2P | Select K₂ if: | Otherwise: If | Update: |
| | | | (Out- | Distance[J] | Distance [J] |
| | | | degree[K₁] > 1 | via K₁ and K₂ | Prev_node_p2mp_flag[J] |
| | | | and Out- | are same, | Previous node[J] |
| | | | degree[K₂] = 0). | select K₁ as | Out-degree[K₁] |
| | | | Else break tie | K₁'s router id | Out-degree[K₂] |
| | | | using distance | is less | |
| | | | [J] as in | | |
| | | | Bellman-Ford | | |
| | | | Algorithm | | |

| | | | | |
|---|---|---|---|---|
| E | Not Known | K2 is P2P or | K2 is chosen | Update: |
| | | P2MP | | Distance [J] |
| | | | | Prev_node_p2mp_flag[J] |
| | | | | Previous node[J] |
| | | | | Out-degree[K₁] |
| | | | | Out-degree[K₂] |

Using the above extending Bellman-Ford algorithm 242, an exemplary embodiment is now described with reference to FIGS. 3A-3F.

FIG. 3A, illustrates a portion of packet communication system 100 of FIG. 1 with node A as a source node 322 and a P2 MP node (as indicated by the square shape of the node). From source node 322 A, node H and node I are reached, setting the prev_node_p2 mp_flag of both node H and node I to be TRUE.

FIG. 3B illustrates moving from node H to node G, node I and node E. In this instance, node I has an incoming transmission link from node A (link AI) and an incoming transmission link from node H (link HI). Comparing the prev_node_p2 mp_flag of node I with the p2 mp_flag of node H, where node A is a P2 MP switching node and node H is a P2P switching node, the link AI is selected per Case C in Table 1. As can be seen in this iteration, node I is a present node 324, while node A and node H are previous nodes 326 of the present node 324.

FIG. 3C illustrates moving from node I and node H to node E. In this iteration, node E is the present node while node I and node H are previous nodes. At node E there are two incoming transmission links (IE and HE). Comparing the prev_node_p2 mp_flag of node E with the p2 mp flag of node 1, transmission link IE is selected per Case D (both previous nodes being P2P nodes) in Table 1 with the update of the variables and flags as shown in the Action column. Link HE is removed, since if link HE was selected, the degree of node E would be greater than two. Node G only has one incoming link (link HG), so no analysis of node G is required.

FIG. 3D illustrates moving from node G to node F, and from node E to node C and node D. From node F, node E is reached, where at node F there are two incoming transmission links (link IE and link FE) from two P2P nodes. No updating is necessary in this case. FIG. 3E illustrates moving from node C to node B. At node B there are two incoming transmission links (link CB and link FB). In this iteration, node B is the present node and node C and node F are the previous nodes. Link CB is selected per Case C in table 1 as node C is a P2 MP switching node while node F is a P2P switching node. From node C, node D is reached. From case C in Table 1, link CD is selected over link ED.

FIG. 3F illustrates moving from node B to node F. With node F being the present node and nodes G and B being previous nodes, Case B yields link BF over link GF. The final spanning tree is a degree-constrained MST 350 where each P2P switching node (circle nodes) have a degree of not more than two 334. For example, node 1, which is a P2P switching node, has one inbound undirected transmission link 330 and one outbound undirected transmission link 332. In the embodiment shown, the extended Bellman-Ford algorithm 242 works for both directed and undirected topologies and requires only a slight modification to the Bellman-Ford algorithm. In an embodiment, the extended Bellman-Ford algorithm 242 has the same time complexity as the standard Bellman-Ford algorithm (O(V,E), where V is the number of switching nodes and E are the number of transmission links).

In an embodiment, the extended Bellman-Ford algorithm 242 may be heuristic, and there may be topologies of packet communication system 100 which will not yield a degree-constrained minimum spanning tree with all P2P switching nodes limited to a degree of not more than two using the extended Bellman-Ford algorithm 242 alone.

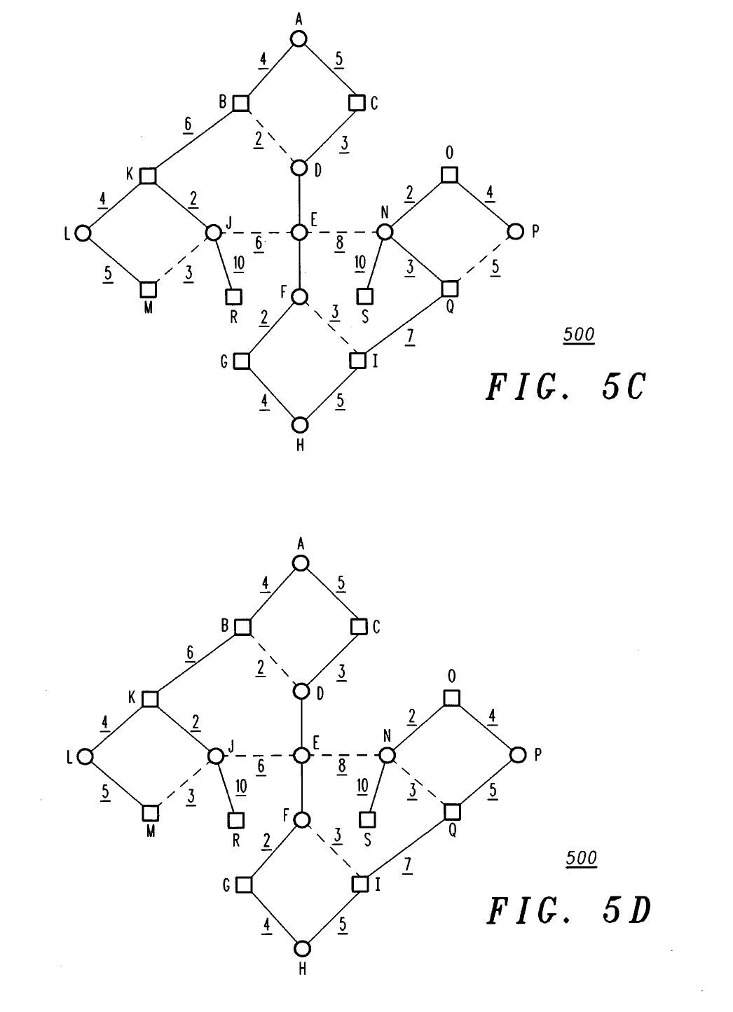

FIG. 4 representatively illustrates a packet communication system 400 in accordance with yet another exemplary embodiment of the present invention. The embodiment shown in FIG. 4 illustrates a portion of a degree-constrained MST generated using the extended Bellman-Ford algorithm 242 where link replacement algorithm 244 may be invoked when the extended Bellman-Ford algorithm 242 does not yield a degree-constrained MST with all P2P switching nodes having a degree of not more than two. In other words, link replacement algorithm 244 may correct all the non-conforming P2P switching nodes (ones that have a degree more than two). The solid lines represent transmission links included in the degree-constrained MST and the dashed line indicates a transmission link not included in the degree-constrained MST. Further, the two links represented between node Z and node X are directed transmission links.

As shown in FIG. 4, the extended Bellman-Ford algorithm 242 yielded a degree-constrained MST where at least one of the P2P switching nodes (node Z) has a degree greater than two. With the degree-constrained MST generated, node Z violates the degree constraint rule (a degree no more than two), and therefore, is not the optimum degree-constrained MST. To remedy this, link replacement algorithm 244 may be executed on the MST shown.

To begin, a to_adjust_list is generated that contains all of the P2P switching nodes that have a degree more than two. A to_test_list is generated that contains all of the transmission links in the topology that are not currently included in the degree-constrained MST generated by extended Bellman-Ford algorithm 242. The to_test_list is sorted in ascending order according to the distance of each link. A hop_away flag is initialized at one, meaning one hop away from a non-conforming P2P node (node Z). For each of the nodes in the to_adjust_list, a to_adjust_hop_away_list is generated of all nodes hop_away from each node in the to_adjust_list. Further, as link replacement algorithm 244 progresses, a to_test2_list may be generated that contains transmission links removed from MST while performing link replacement algorithm 244.

For each node in the to_adjust_list, for example node Z, the following procedure may be performed. Beginning at the top of the to_test_list (the links with the smallest distance), check if any link in the to_test_list, say link XY, can be added to the MST satisfying the following constraints:
a) The link XY should pass through any of the connected nodes, say node X, of the to_adjust_node (i.e. node Z).
b) Initialize a link_to_remove as a link with a start-node the same as the to_adjust_node (node Z) and end-node as the connected node to the to_adjust_node (link ZX). If the connected node (node X) is the parent node in the MST, then link_to_remove is a link with start-node as the connected node (node X) to the to_adjust_node (node Z) and end-node same as the to_adjust_node (link XZ). This is done to preserve the direction of flow in the MST.
c) Adding the current to_test_link and removing the link_to_remove should:
   c1) make the to_adjust_node adjusted (the degree of the non-conforming node should be reduced by one)
   c2) not add any new node to the to_adjust_list
d) By adding the to_test_link and removing the link_to_remove, the MST should still be connected (all of the nodes in the topology are reachable from the source node).

If the above conditions (a-d) are satisfied, then the new link (link XY) is added to the MST and link_to_remove (link XZ) is removed (both link XZ and link ZX are removed). The removed link is added to the to_test2_list and the to_test2_list is sorted in ascending order according the distance of each link in the list. The above steps may be repeated until the to_adjust_node (node Z) is removed from the to_adjust_list. Further, the above steps may be repeated for each node in the to_adjust_list.

If no solution is found, then the above procedure may be repeated ignoring one or more of constraints (c1) and (c2). If still no solution is found and the to_test_list is exhausted, then links in the to_test2_list may be considered. If still no solution is found, then the procedure may be repeated by incrementing hop_away by one (i.e. increment hop_away to two and consider nodes two hops away from the to_adjust_node). If hop_away reaches one less than the number of nodes in the MST and no solution is found, then no solution is possible for the given topology.

In an embodiment, the above link replacement algorithm 244 may correct non-conforming P2P switching nodes that have a degree more than two after executing the extended Bellman-Ford algorithm 242. The time complexity of link replacement algorithm 244 is O(V²,E), where V is the number of switching nodes and E are the number of transmission links.

In an embodiment, the link replacement algorithm 244 may be heuristic, and there may be topologies of packet communication system which will not yield a degree-constrained MST with all P2P switching nodes limited to a degree of not more than two. Further, the combination of the extended Bellman-Ford algorithm 242 and link replacement algorithm 244 may be heuristic, and there may be topologies of packet communication system 100 which will not yield a degree-constrained minimum spanning tree with all P2P switching nodes limited to a degree of not more than two using the extended Bellman-Ford algorithm 242 and link replacement algorithm 244.

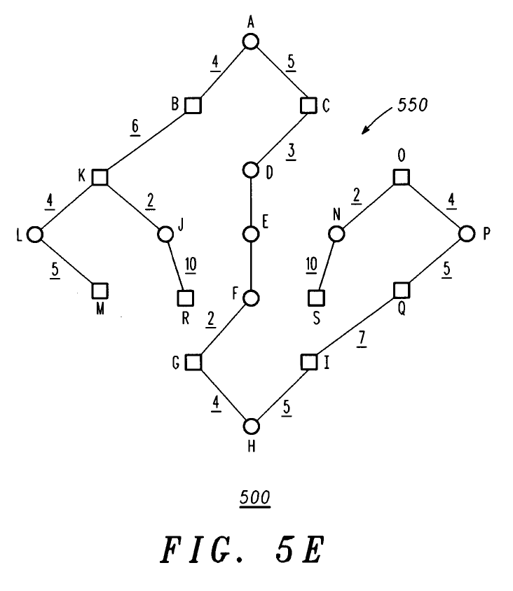

FIG. 5 representatively illustrates a packet communication system 500 in accordance with still another exemplary embodiment of the present invention. FIG. 5 has been segmented into FIGS. 5A-5E to exemplarily illustrate the steps of the link replacement algorithm 244. The packet communication system 500 shown may be representative of a topology 501 for the multicast distribution of video, other packetized data, and the like, where a source node (for example node C) distributes to one or more destination nodes 505 via a plurality of transmission links 508. The respective distance of each of the plurality of transmission links are shown as underlined numbers.

FIG. 5A illustrates a topology 501 of a packet communication system 500 after execution of extended Bellman-Ford algorithm 242, which has returned a degree-constrained MST with non-conforming P2P switching nodes that have a degree greater than two. P2P switching nodes 504 are represented by circular nodes and P2 MP switching nodes 506 are represented by square nodes. In the embodiment shown, transmission links included in the MST 510 are shown as solid lines, while transmission links not in the MST 512 are shown as dashed lines.

In the embodiment shown, three P2P switching nodes are non-conforming as they each have a degree greater than two (nodes D, E and N). So the to_adjust_list contains node D, node E and node N. The to_adjust_hop_away list represents each node that is (initially) one hop away from the to_adjust_node. This may be represented with the to_adjust_node followed by its respective to_adjust_hop_away nodes in parenthesis. To_adjust_list: D(E, B, C^{P}), E(N, F, D^{P}), N(O, S, E^{P}), where the superscript “P” represents the parent node in each case. The to_test_list includes the links not included in the MST 512 sorted by ascending distance: QN(3), NQ(3), FI(3), IF(3), JM(3), MJ(3), AB(4), BA(4), PQ(5), QP(5), JE(6), EJ(6). First, to_adjust_node D will be fixed. The links under consideration for replacement are links DE, DB and CD. The conditions for adding a link from the to_test_list are now considered. Links QN, NQ, FI, IF, JM and MJ are not considered as they do not contain a node that is connected to D (condition (a) above). Link AB may be considered as it contains node B, which is connected to node D. Link AB may be added and link DB removed as this satisfies all of the above conditions:
Condition (a)—The new link (AB) passes through a node connected to the to_adjust_node;
Condition (b)—the direction of flow in the MST is preserved;
Condition (c1)—node D's degree is decreased by 1;
Condition (c2)—adding link AB does not add any new node to the to_adjust_list; and
Condition (d)—the MST is still connected—can reach all other nodes from source node C.

The new MST after correcting node D is shown in FIG. 5B, where link AB is now solid and link DB is now dashed. The new to_adjust_list is E(N, F, D^{P}), N(O, S, E^{P}). The new to_test_list is QN(3), NQ(3), FI(3), IF(3), JM(3), MJ(3), PQ(5), QP(5), JE(6), EJ(6). The to_test2_list is DB(2), BD(2).

Now node E will be fixed. Links PQ and QP do not contain a node connected to node E. Other links from the to_test_list cannot be added without a degree violation (condition c2). Adding links IF or FI would add node F to the to_adjust_list. Adding links JM, MJ, EJ or JE would add node J to the to_adjust_list. Adding QN and removing link EN satisfies all conditions:
Condition (a)—The new link (QN) passes through a node connected to the to_adjust_node;
Condition (b)—the direction of flow in the MST is preserved;
Condition (c1)—node E's degree is decreased by 1;
Condition (c2)—adding link QN does not add any new node to the to_adjust_list; and
Condition (d)—the MST is still connected—can reach all other nodes from source node C.

The new MST after correcting node E is shown in FIG. 5C, where link QN is now solid and link EN is now dashed. The new to_adjust_list is N(O, S, Q^{P}). The new to_test_list is FI(3), IF(3), JM(3), MJ(3), PQ(5), QP(5), JE(6), EJ(6). The to_test2_list is DB(2), BD(2), EN(8), NE(8).

Now node N will be fixed. Links FI, IF, MJ and JM do not contain a node connected to node N. Adding link PQ will not satisfy condition (d) as the MST will not be connected (where PQ is directional from P to Q, and using PQ will isolate nodes P, 0 and N). Adding link QP and removing link QN will satisfy all of the conditions:
Condition (a)—The new link (QP) passes through a node connected to the to_adjust_node;
Condition (b)—the direction of flow in the MST is preserved;
Condition (c1)—node N's degree is decreased by 1;
Condition (c2)—adding link QP does not add any new node to the to_adjust_list; and
Condition (d)—the MST is still connected—can reach all other nodes from source node C.

The new MST after correcting node E is shown in FIG. 5D, where link QP is now solid and link QN is now dashed. The new to_adjust_list is empty. The new to_test_list is FI(3), IF(3), JM(3), MJ(3), JE(6), EJ(6). The to_test2_list is DB(2), BD(2), NQ(3), QN(3), EN(8), NE(8).

The degree-constrained MST 550 is now shown in FIG. 5E without the links that are not included in the MST 550. All of the P2P nodes now have a degree of not greater than two. The degree-constrained MST 550 may be used to establish the LSP 250.

The above extended Bellman-Ford algorithm and link replacement algorithm has the advantage of not increasing the complexity of running the standard Bellman-Ford algorithm, with only the addition of the link replacement algorithm (if necessary). The above algorithms also have the advantage of working for both directed and undirected topologies. The final degree-constrained MST may not have the least cost, but may be near to optimal cost.

In the foregoing specification, the invention has been described with reference to specific exemplary embodiments. However, it will be appreciated that various modifications and changes may be made without departing from the scope of the present invention as set forth in the claims below. The specification and figures are to be regarded in an illustrative manner, rather than a restrictive one and all such modifications are intended to be included within the scope of the present invention. Accordingly, the scope of the invention should be determined by the claims appended hereto and their legal equivalents rather than by merely the examples described above.

For example, the steps recited in any method or process claims may be executed in any order and are not limited to the specific order presented in the claims. Additionally, the components and/or elements recited in any apparatus claims may be assembled or otherwise operationally configured in a variety of permutations to produce substantially the same result as the present invention and are accordingly not limited to the specific configuration recited in the claims.

Benefits, other advantages and solutions to problems have been described above with regard to particular embodiments; however, any benefit, advantage, solution to problem or any element that may cause any particular benefit, advantage or solution to occur or to become more pronounced are not to be construed as critical, required or essential features or components of any or all the claims.

Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

We claim:

1. A packet communication system, comprising:
a plurality of packet switching nodes, comprising:
a plurality of point-to-point (P2P) packet switching nodes for receiving and sending data packets;
a plurality of point-to-multi-point (P2 MP) packet switching nodes for sending and receiving the data packets;
a plurality of transmission links coupling pairs of the plurality of packet switching nodes, wherein each of the plurality of transmission links has a distance; and
a path computation module for determining a degree-constrained minimum spanning tree (MST) of the packet communication system such that each of the plurality of P2P packet switching nodes has a degree of two, wherein an extended Bellman-Ford algorithm successively analyzes each of the plurality of packet switching nodes as a present node and calculates the degree-constrained MST as a function of the distance of each of the plurality of transmission links and whether a previous node from the present node is one of the plurality of P2P packet switching nodes or one of the plurality of P2 MP packet switching nodes.

2. The packet communication system of claim 1, wherein the extended Bellman-Ford algorithm sets one of the plurality of packet switching nodes to the present node and determines which one of the plurality of transmission links coupled to one of a plurality of previous nodes and to the present node to include in the degree-constrained MST based on the distance of the one of the plurality of transmission links and whether the one of the plurality of previous nodes is one of the plurality of P2P packet switching nodes or one of the plurality of P2 MP packet switching nodes.

3. The packet communication system of claim 1, wherein each of the plurality of P2P packet switching nodes in the degree-constrained MST includes only one inbound undirected transmission link and one outbound undirected transmission link.

4. The packet communication system of claim 1, wherein the path computation module executes a link replacement algorithm such that each of the plurality of P2P packet switching nodes has the degree of two.

5. The packet communication system of claim 4, wherein the link replacement algorithm is coupled to replace at least one of the plurality of transmission links in the degree-constrained MST with at least one of the plurality of transmission links not in the degree-constrained MST such that each of the plurality of P2P packet switching nodes has the degree of two.

6. In a packet communication system, a method of generating a degree-constrained minimum spanning tree (MST), comprising:
providing a plurality of packet switching nodes for sending and receiving data packets, wherein the plurality of packet switching nodes comprise a plurality of point-to-point (P2P) packet switching nodes and a plurality of point-to-multi-point (P2 MP) packet switching nodes;
providing a plurality of transmission links coupling pairs of the plurality of packet switching nodes, wherein each of the plurality of transmission links has a distance;
calculating the degree-constrained MST such that each of the plurality of P2P packet switching nodes has a degree of two, wherein calculating comprises:
an extended Bellman-Ford algorithm successively analyzing each of the plurality of packet switching nodes as a present node; and
the extended Bellman-Ford algorithm calculating the degree-constrained MST as a function of the distance of each of the plurality of transmission links and whether a previous node from the present node is one of the plurality of P2P packet switching nodes or one of the plurality of P2 MP packet switching nodes.

7. The method of claim 6, wherein calculating further comprises:
the extended Bellman-Ford algorithm setting one of the plurality of packet switching nodes to the present node; and
determining which one of the plurality of transmission links coupled to one of a plurality of previous nodes and to the present node to include in the degree-constrained MST based on the distance of the one of the plurality of transmission links and whether the one of the plurality of previous nodes is one of the plurality of P2P packet switching nodes or one of the plurality of P2 MP packet switching nodes.

8. The method of claim 7, wherein if the plurality of previous nodes consist of one of the plurality of P2P packet switching nodes and one of the plurality of P2 MP packet switching nodes, selecting the one of the plurality of transmission links coupled to the one of the plurality of P2 MP packet switching nodes and the present node.

9. The method of claim 7, wherein if the plurality of previous nodes consist of two of the plurality of P2P packet switching nodes, and if one of the plurality of previous nodes has a outgoing degree greater than 1 and another one of the plurality of previous nodes has an outgoing degree equal to zero, then selecting the one of the plurality of transmission links coupled to the present node and the one of the plurality of previous nodes having the degree equal to zero.

10. The method of claim 6, wherein each of the plurality of P2P packet switching nodes in the degree-constrained MST includes only one inbound undirected transmission link and one outbound undirected transmission link.

11. The method of claim 6, wherein calculating further comprises executing a link replacement algorithm on the degree-constrained MST such that each of the plurality of P2P packet switching nodes has the degree of two.

12. The method of claim 11, wherein executing the link replacement algorithm comprises replacing at least one of the plurality of transmission links in the degree-constrained MST with at least one of the plurality of transmission links not in the degree-constrained MST such that at least one of the plurality of P2P packet switching nodes is decreased to the degree of two.

13. The method of claim 12, wherein replacing further comprises failing to cause any of the plurality of P2P packet switching nodes to have the degree greater than two.

14. A method of establishing a labeled switch path (LSP) from a source node to a destination node in a packet communication system, comprising:
providing a topology of the packet communication system, the topology comprising:
a plurality of packet switching nodes for sending and receiving data packets, wherein the plurality of packet switching nodes comprise a plurality of point-to-point (P2P) packet switching nodes and a plurality of point-to-multi-point (P2 MP) packet switching nodes;
a plurality of transmission links each having a distance, wherein the plurality of transmission links couples pairs of the plurality of packet switching nodes;
requesting the LSP from the source node to the destination node in the topology;
calculating the LSP such that each of the plurality of P2P packet switching nodes in the LSP has a degree of two, wherein calculating comprises:
an extended Bellman-Ford algorithm successively analyzing each of the plurality of packet switching nodes as a present node; and
the extended Bellman-Ford algorithm calculating the LSP as a function of the distance of each of the plurality of transmission links and whether a previous node from the present node is one of the plurality of P2P packet switching nodes or one of the plurality of P2 MP packet switching nodes.

15. The method of claim 14, wherein calculating further comprises:
the extended Bellman-Ford algorithm setting one of the plurality of packet switching nodes to the present node; and
determining which one of the plurality of transmission links coupled to one of a plurality of previous nodes and to the present node to include in the LSP based on the distance of the one of the plurality of transmission links and whether the one of the plurality of previous nodes is one of the plurality of P2P packet switching nodes or one of the plurality of P2 MP packet switching nodes.

16. The method of claim 15, wherein if the plurality of previous nodes consist of one of the plurality of P2P packet switching nodes and one of the plurality of P2 MP packet switching nodes, selecting the one of the plurality of transmission links coupled to the one of the plurality of P2 MP packet switching nodes and the present node.

17. The method of claim 15, wherein if the plurality of previous nodes consist of two of the plurality of P2P packet switching nodes, and if one of the plurality of previous nodes has a outgoing degree greater than 1 and another one of the plurality of previous nodes has an outgoing degree equal to zero, then selecting the one of the plurality of transmission links coupled to the present node and the one of the plurality of previous nodes having the degree equal to zero.

18. The method of claim 14, wherein calculating further comprises executing a link replacement algorithm such that each of the plurality of P2P packet switching nodes has the degree of two.

19. The method of claim 18, wherein executing the link replacement algorithm comprises replacing at least one of the plurality of transmission links in the LSP with at least one of the plurality of transmission links not in the LSP such that at least one of the plurality of P2P packet switching nodes is decreased to the degree of two.

20. The method of claim 19, wherein replacing further comprises failing to cause any of the plurality of P2P packet switching nodes to have the degree greater than two.
